(19) United States
(12) Patent Application Publication
(10) Pub. No.: US 2022/0343377 A1
(43) Pub. Date: Oct. 27, 2022

(54) AUTOMATED PRICING MECHANISM

(71) Applicants: Samir Narendra Mehta, Seattle, WA (US); Christian Kwon, Seattle, WA (US); Douglas Stevens, Seattle, WA (US); Srinivas Chakravarthy, Seattle, WA (US); Steven Huggard, Seattle, WA (US)

(72) Inventors: Samir Narendra Mehta, Seattle, WA (US); Christian Kwon, Seattle, WA (US); Douglas Stevens, Seattle, WA (US); Srinivas Chakravarthy, Seattle, WA (US); Steven Huggard, Seattle, WA (US)

(73) Assignee: Wrench IP Holding Company, Seattle, WA (US)

(21) Appl. No.: 17/239,220

(22) Filed: Apr. 23, 2021

(51) Int. Cl. G06Q 30/02; G06Q 10/08; G06Q 10/00; G06Q 10/10; G06F 16/23

(52) U.S. Cl. CPC G06Q 30/0283; G06Q 10/0875; G06Q 10/20; G06Q 10/101; G06F 16/2365; G06N 20/00

(57) ABSTRACT

An instant pricing system and mechanism includes pricing templates for each vehicle/service combination, which are created by reference to an automobile's make, model, year, engine, transmission, drivetrain, and trim. Also, a job quote is created by reference to parts, labor times and suggested pricing through use of historical job data, 3rd party information, fleet contracts and service team inputs, in an iterative approach. The created Job quotes are linked to pricing templates to capture all pricing edits into the template.

### FIELD OF THE INVENTION

Embodiments of the present disclosure generally relate to a system and mechanism for an automated instant pricing system and mechanism aiming to provide fair and transparent pricing to the customer for services requiring parts and labor, while enabling a business to generate optimal margin and a consistent pricing across all national and international markets with a detailed breakdown of parts and labor as well as the flexibility to add or remove services from a quote.

### BACKGROUND OF THE INVENTION

Providing instant pricing for services requiring product parts and labor has long been a goal of modern businesses. The reason is clear; instant pricing saves time, encourages fast decision making by the consumer, and saves resources.

Conventional methods for pricing for such tasks are manual and complex as they require providing cost estimates for many complex services. In the field of car repair, for example, the process includes consideration of many manufacturers of vehicles and parts, type of vehicles, models, year of manufacture, type of trims (add on packages) and engine types—all of which influence the way a service must be performed and dictates parts that can be utilized. Additionally, there are many different types of parts, with different types of specifications, price, and quality. To add to the complexity, some parts require that ‘sibling’ parts be changed at the same time to avoid breakage or malfunction over time.

Conventional pricing mechanisms rely heavily on navigating part providers' web sites such as napaonline.com, amazon.com or oreillyauto.com, calling retail shops over the phone, or looking up the web sites of third-party service providers for parts and labor cost estimates such as Epicor.com or Motor.com. Apart from taking a significant amount of time to manually search for and calculate applicable prices, these methods suffer from several deficiencies, including missing part specifications and inconsistent data formats, which, in turn, have made it challenging to build a reliable and scalable instant pricing mechanism.

Conventional methods for automated pricing for car repair tasks involve integrating with individual parts and labor providers such as Epicor and Motor using their proprietary Application Programming Interfaces (API). A main disadvantage of the conventional instant pricing systems is the presence of major gaps in their frameworks, and noisy data. The data returned by the API of these systems are inconsistent, missing details, or have incorrect details altogether. As a result—many such systems suffer from fragmented external sources of information and incomplete and/or inaccurate data as a result of integration with providers such as Epicor and Motor.

Another source of inadequacy of the conventional systems is their failure to utilize parts, labor hours and pricing from historical jobs to build automated priced quotes.

Yet another shortcoming of conventional instant pricing system is their inability to offer optimal margins and uniform pricing in markets where such services are available, to allow Fleet customers to reliably forecast their service budgets. In addition, the calculations and methods, which use information captured from local providers, are often inconsistent.

Yet another shortcoming of conventional instant pricing system is their failure to save edited quotes, e.g., those by the service team, in a reusable, structured format.

Conventional instant pricing systems additionally suffer from an inability to perform proactive audits and update parts/labor hours, inability to flag automated priced jobs proactively for review based on confidence level, defined bell-curve, and inability to support rules for customized pricing for scenarios such as Fleet contractual pricing, as well as separation of concerns between parts, labor, and pricing.

Therefore, there is a need for an instant price mechanism which addresses the above deficiencies of the conventional systems, to increase accuracy, remove manual intervention, improve customer conversion as well as customer experience and trust, address fleet pricing requirements, improve confidence in instant pricing, optimize engagement with part vendors and optimize parts revenues, provide customizable logic and pricing target needs and accelerate automation for new services.

### SUMMARY OF THE PRESENT DISCLOSURE

The present disclosure is related to a system and mechanism of instant pricing that provides fair and transparent pricing to the customer for vehicle repair services, with a detailed breakdown of parts and labor as well as the flexibility to add or remove services from a quote.

The present disclosure provides the flexibility and specificity missing from conventional pricing systems by creating a pricing template, which not only applies to a vehicle/service, but is specific to a vehicle make, model, year, trim, engine, and service. The inventive “Wrench” system and mechanism enables capture of all elements specific to the combination required to calculate pricing in one place and to utilize the data repeatedly and consistently without any additional look ups at a later stage.

In one embodiment, the inventive Automated Instant Pricing Mechanism creates a unique Pricing Template for each vehicle/service combination, including labor times, reference parts, part providers and cost of part by provider, by location, and Wrench Suggested Retail Pricing (WSRP). The Pricing Template will use historical job data, 3rd party information, pre-defined rules for contexts such as customer contracts and a manual review mechanism by experts, utilizing an iterative approach to build high confidence pricing. Job quotes will be deeply linked to pricing templates to capture all pricing edits into the template.

A baseline pricing system is created that can be applied to a vehicle/service in all markets. Part selection is specific to the job quote, which is independent of price quoted to the customer. Part selection is specific to the job requested by the customer and independent of the price quoted to the customer. Cost savings from part selection add to the baseline margin defined in the suggested retail price.

Creation of “Smart Templates” is a key aspect of the inventive Automated Instant Price Mechanism. Toward that end, pricing templates will be directly used for automated price quotes for a given vehicle/service. An iterative expert in loop auditing process is used to increase accuracy and reliability of the Smart Templates. Templates are designed to evolve with business needs, business models and will be backward compatible. They will also track changes made and use that data for self-alerting and self-correction.

In more detail, the workings of the inventive Automated Instant Price Mechanism are described below.

A smart pricing template is automatically generated by the system upon placement of an order by a customer online using desktop or mobile or a messaging system such as SMS. Alternatively, if a customer places an order over the phone, a pricing template is automatically created when a service team member enters the customer's order into the system. A pricing template may also be generated by an automated backend process, that utilizes information sources such as customer and market segments, vehicle sales information, and partner data to provide vehicle and service inputs for the template. The parts and the labor lists components of the template are created by algorithms referring to historical jobs and when needed, calling an API offered by integrated parts and labor providers such as Epicor or other 3rd party APIs. After running a different set of algorithms that clean and normalize the data received a Wrench Suggested Retail Price (WSRP) is generated based on pre-defined or dynamic rules and backend logic. A Link Quote links each quote to one or more templates. Following the trust but verify periodically model, and to ensure auto-created data integrity, experts in loop such as service and revenue team can review, audit and edit parts/labor list and suggested pricing on-demand. Alternately, the pricing engine itself can trigger an audit, if it detects discrepancy when comparing historical pricing with prices triangulated between one or more providers such as Epicor, or if it detects that the data captured or calculated WSRP are not within a specified bound associated with service types or does not meet pre-defined error margins, or they are dynamically determined to be a suspect using specific algorithms. The pricing engine may also include machine learning algorithms to learn from manual corrections to automatically correct pricing templates based on discrepancies in job prices. A repository is used to save templates along with complete activity log and edit history.

In more detail, the inventive Automated Instant Pricing Mechanism is comprised of the following steps:

In STEP 1, a Smart Pricing Template (SPT) is triggered when a customer requests or a backend process triggers a booking quote for one or more services on the website. In response, the backend programmatically generates a pricing template using historical job data or a revenue or service team member initiates a booking.

In STEP 2, the SPT algorithm generates a parts reference list for the vehicle/service combination, using the following data sources:
1. The algorithm checks for vehicles that are similar to the vehicle profile (such as same make, model, model, drive train, trim, +/−3 years from year of vehicle, or based on vehicle model generation). For selected vehicles and the service code, the algorithm may fetch all the parts used in historical jobs.
2. The parts reference list for the specific vehicle model and service code is obtained from Epicor or other third-party services.

In STEP 3, the Pricing Template algorithm generates a labor reference list for the vehicle/service combination, using the following data sources:
1. Labor used in historical jobs for similar vehicle profiles. In that regard, the algorithm checks for vehicles that are similar to the vehicle profile (e.g., same make, model+/−3 years from year of vehicle, or based on vehicle model generation). For selected vehicles and the service code, the algorithm parses the labor hours across all the jobs and calculates a representative value of hours while taking into consideration outliers; if there is a big variance across all the jobs, it will trigger a manual audit.
2. Epicor and other 3rd party API Responses. The labor and parts reference list for the specific vehicle model and service code is obtained from the Epicor service. The data received from Epicor goes through a data-pipeline where it is cleaned, normalized, and reviewed for integrity. The data received is then compared against data received from multiple 3^{rd} party sources to determine whether it is within specified bounds or error margins.

In STEP 4 of the inventive Automated Instant Pricing Mechanism, the pricing template algorithm generates a labor reference list for the vehicle/service combination, using the following data sources:
1. Where comparable historical jobs for the vehicle/service exist, the inventive Pricing Template algorithm selects optimal parts from the job. In cases where no historical jobs exist, processed parts pricing is used from Epicor/other 3rd party integrations.
2. In cases where comparable historical jobs for the vehicle/service exist, the algorithm selects the optimal labor hours across all jobs as the baseline labor hours. In cases where no historical jobs exist, labor hours are used from Epicor/other 3rd party integrations.

In STEP 5, the pricing template is linked to a job quote. Accordingly, every service in a job quote is linked to its corresponding pricing template. The pricing template is already available or generated when the job request is triggered. The total pricing of the job is the sum of prices across all services i.e., pricing templates.

In STEP 6 service/revenue team members are able to edit pricing templates, which are linked to job quotes. In one embodiment of the present invention, the following edits are permitted.
1. New parts added to the job quote are automatically updated to the parts reference list. To update the pricing in the template, an authorized user can add the new part to the pricing list to the parts used in suggested pricing.
2. Authorized users can edit the price of a part used in the suggested pricing, delete a part used in suggested pricing and replace a part used in suggested pricing with apart from the reference list.
3. Authorized users can edit the number of labor hours used to compute the suggested pricing.

In STEP 7, pricing templates with updates in the parts reference list or suggested pricing are saved to the template repository. The updated template will be used for automated pricing quotes in the future. Each Template will have a comprehensive activity log, that will track all changes made to the Template.

In one embodiment, key aspects of the inventive templating workflow comprise the following:

An Audit WorkGroup. All pricing templates will be available for audit by a designated audit workgroup. The workgroup audits automatically priced templates created by the engine, as well as initiate periodic audits of templates and revise reference lists and suggested pricing calculations if required.
1. Template Confidence Scores. Every Pricing Template will have an associated confidence score to indicate the accuracy of pricing. When Templates are auto generated; the confidence score is based on a number of triangulated sources. Authorized users can increase confidence scores when they edit the Template. The confidence score is automatically updated by the pricing engine.
2. Automated Triggers. Frequent deviations of quote pricing from suggested template prices (such as frequent discounts on job quotes) will automatically reduce the confidence score of a Template and notify the audit workgroup for review.
3. Smart Template Status. Each Pricing Template can have a status of ‘Under Review’ when it is generated for the first time, or when edits are made by a user outside the audit workgroup Templates have a status of ‘Approved’ or ‘Suspended’ when specified by an audit workgroup user.

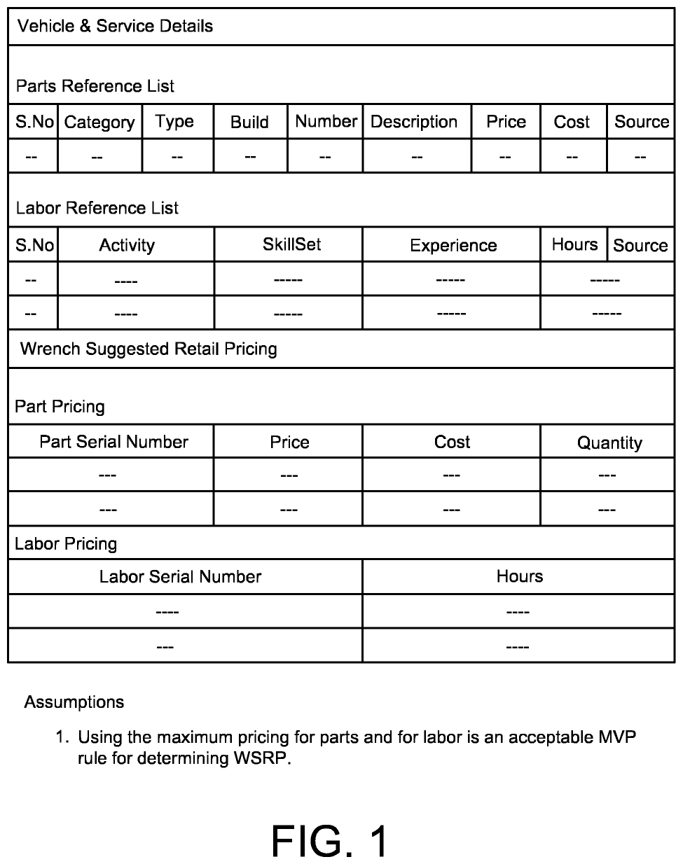

FIG. 1 is a schematic diagram according to an exemplary embodiment of the present disclosure.

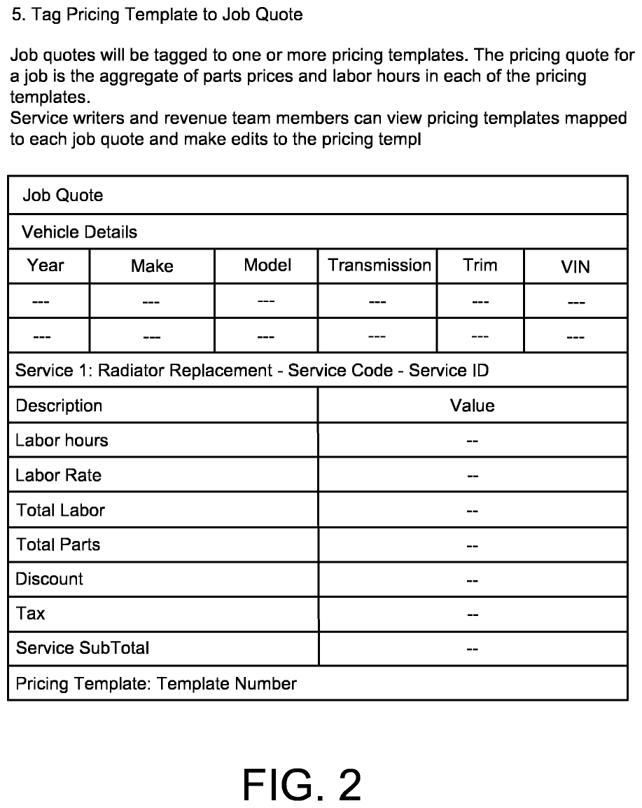

FIG. 2 is a schematic diagram according to an exemplary embodiment of the present disclosure.

In addition to the pricing templates, the pricing engine also includes a dynamic pricing algorithm that takes into account multiple factors such as customer segments, existing commercial agreements, prior purchase patterns, vehicle details to dynamically calculate pricing that can be offered. This dynamic pricing algorithm is built using proprietary AI/ML systems that combine multiple sources of data such as customer market, vehicle model, parts prices etc.

What is claimed is:

1. An instant pricing system and mechanism comprised of:
creating pricing templates for each vehicle/service combination, which are created by reference to an automobile's make, model, year, engine, transmission, drivetrain, and trim.
creating a job quote by reference to parts and labor times and suggested pricing through use of historical job data, 3rd party information, fleet contracts and service team inputs, in an iterative approach.
wherein the created Job quotes are linked to pricing templates to capture all pricing edits into the template.

2. The pricing system and mechanism of claim 1, wherein an algorithm generates the parts reference list for the vehicle/service combination, using the following data sources:
checking for vehicles that are similar to the vehicle profile and fetching all the parts used in historical jobs for selected vehicles and the service code; wherein the parts reference list for the specific vehicle model and service code is obtained from Epicor or other third-party services;
checking for labor reference list for the vehicle/service combination, using labor used in historical jobs for similar vehicle profiles parsing the labor hours across all the jobs and calculating value of hours.

3. The pricing system and mechanism of claim 2, wherein data received from third party service goes through a data-pipeline where it is cleaned, normalized, and reviewed for integrity.

4. The pricing system and mechanism of claim 3, wherein the data received is then triangulated with data received from multiple 3rd party sources to determine whether it is within specified bounds or error margins.

5. The instant pricing mechanism of claim 4, wherein the pricing template algorithm generates a labor reference list for the vehicle/service combination, using the following data sources:
Where comparable historical jobs for the vehicle/service exist, selecting parts from the job that generated the highest margin on parts revenue. In cases where no historical jobs exist, cleaned parts pricing is used from Epicor/other 3rd party integrations.
In cases where comparable historical jobs for the vehicle/service exist, selecting the average labor hours across all jobs as the baseline labor hours. In cases where no historical jobs exist, labor hours are used from Epicor/other 3rd party integrations.

6. The pricing mechanism of claim 1, wherein the pricing template is linked to a job quote.

7. The pricing template of claim 6, wherein the pricing template is linked to a job quote resulting in every service in a job quote being linked to its corresponding pricing template.

8. The pricing template of claim 6, wherein the pricing template is available or generated when the job request is triggered.

9. The pricing template of claim 8, wherein total pricing of the job is the sum of prices across all services i.e., pricing templates.

10. The pricing template of claim 1, wherein service/revenue team members are able to edit pricing templates, which are linked to job quotes.

11. The pricing template of claim 10, wherein the following edits are permitted:
new parts added to the job quote are automatically updated to the parts reference list. To update the pricing in the template, an authorized user can add a new part to the pricing list which will be used in suggested pricing.
authorized users can edit the price of a part used in the suggested pricing, delete a part used in suggested pricing and replace a part used in suggested pricing with apart from the reference list.
authorized users can edit the number of labor hours used to compute the suggested pricing.

12. The pricing template of claim 1, wherein the pricing templates with updates in the parts reference list or suggested pricing are saved to the template repository to be used for automated pricing quotes in the future, wherein each Template will have a comprehensive activity log, that will track all changes made to the Template.

13. The automated instant pricing system and Mechanism of claim 1, further including an audit work group for automatically pricing engine triggered audits, as well as initiating periodic audits of templates and revise reference lists and suggested pricing calculations if required.

14. The automated instant pricing system of claim 1 further including an associated confidence score to indicate the accuracy of pricing. When Templates are auto generated, the confidence score is based on a number of triangulated sources. Authorized users can increase confidence scores when they edit the Template.

15. The instant pricing system and mechanism of claim 14 additionally including automated triggers such as Artificial Intelligence/Machine Learning, wherein frequent deviations of quote pricing from suggested template prices (such as frequent discounts on job quotes) will automatically reduce the confidence score of a Template and notify the audit workgroup for review.
